(19) United States
(12) Patent Application Publication
(10) Pub. No.: US 2026/0329099 A1
(43) Pub. Date: Oct. 22, 2026

(54) OPTICAL EXPANDER OF A LIDAR SYSTEM AND LIDAR SYSTEM

(71) Applicant: VALEO DETECTION SYSTEMS GMBH, Bietigheim-Bissingen (DE)

(72) Inventors: Bernd Bertschinger, Bietigheim-Bissingen (DE); Haiyue Yang, Bietigheim-Bissingen (DE); Thomas Schuler, Bietigheim-Bissingen (DE)

(73) Assignee: VALEO DETECTION SYSTEMS GMBH, Bietigheim-Bissingen (DE)

(21) Appl. No.: 19/122,847

(22) PCT Filed: Oct. 16, 2023
(86) PCT No.: PCT/EP2023/078590

§ 371 Date: Apr. 21, 2025

(30) Foreign Application Priority Data
Oct. 21, 2022 (DE) 10 2022 127 849.2

(51) Int. Cl. G02B 27/09; G01S 7/481; G02B 3/00

(52) U.S. Cl. CPC G02B 27/0966; G01S 7/481; G02B 3/0031; G02B 3/005; G02B 27/0961

(57) ABSTRACT

Disclosed herein is an optical expander for a receiving path of a lidar system, configured to expand at least one light beam for reception by at least one pixel of an optical sensor of the lidar system. The optical expander includes at least one of a concave and/or convex cylinder lens, a structure of a one-sided micro cylinder lens array or a structure of a two-sided micro cylinder lens array. A lidar system is also disclosed herein.

### FIELD

The present disclosure relates to the field of lidar systems with an optical transmitter, an optical receiver and a control unit.

### BACKGROUND

Modern vehicles (cars, vans, trucks, motorcycles, etc.) have a large number of sensors whose data are used for driver information and/or are made available to driver assistance systems. The sensors may detect the vehicle's environment and other road users. Based on the data collected, a model of the vehicle's environment may be generated and the system may react to changes in this vehicle environment.

An important sensor principle for the detection of the environment, e.g. of vehicles, is the lidar technology (lidar engl. Light Detection and Ranging). A lidar system has an optical transmitter and an optical receiver. The transmitter can emit transmitted light. In a lidar system, the light used can be laser light in the ultraviolet, visual or infrared range. The receiving device can receive the emitted light as received light after reflection from an object in the field of view of the lidar system.

Lidar systems are constantly being further improved for various functions, e.g. for the acquisition of environmental information in the near and far range of vehicles, such as passenger cars or commercial vehicles. Lidar systems can also serve as sensor systems for driver assistance systems, in particular assistance systems for autonomous or semi-autonomous vehicle control. In particular, they can be used to detect obstacles and/or other road users in the front, rear or blind spot area of a vehicle.

The received light can be evaluated by a control unit of the lidar system using the transmitted light. The spatial position and distance of the object from which the reflection occurred can be determined. In addition, it is possible to determine a relative velocity. Reflection or reflected light is understood to mean any light that is reflected back and should in particular also include light that is reflected back by scattering or absorption emission.

Scanning lidar systems emit light beams sequentially moving the direction of the beam in a scanning direction. 1D scanning lidar systems perform the scanning in one direction, e. g. the horizontal direction in front of a vehicle. In the 1D scanning lidar system, optical sensors of the optical receiver may have pixels, where the active area has a first dimension along a first axis and a second dimension, which is less than the first dimension. An example for such a sensor is the Sony IMX 449/459. The advantage of this enlargement in one dimension is: one side, the axis with smaller size can maintain the high angle resolution of whole sensor. One other side, the axis with large size can increase the active area of the pixel in order to increase the dynamic range of the sensor.

In US 2020/0096615 A1 an anamorphic camera lens is described which collects and focuses a light beam onto such a pixel with an active area that has a first dimension that is larger than a second dimension perpendicular to the first dimension.

A cylindrical lens array for an optical system is described in US2016/0170287A1. The cylindrical lens array is used to parallelize laser beams in the transmitting light path of a data communication system.

### SUMMARY

An optical expander for a receiving path of a lidar system is configured to expand at least one light beam for reception by at least one pixel of an optical sensor of the lidar system. The optical sensor transforms the optical information into electrical information, which may then be processed afterwards. The expander comprises at least an optical expansion element, which comprises at least one of a concave and/or convex cylinder lens, a structure of a one-sided micro cylinder lens array or a structure of a two-sided micro cylinder lens array. Due to the expansion the energy of the light beam spreads over larger area of the pixel. The area illuminated by the light beam on the pixel may form an elliptical profile. The beam expansion in the receiving path can reduce blooming effect and to an increased dynamic range of the optical sensor. As a result, the detection range of the receiver and the lidar system as a whole may increase.

A concave and/or convex cylinder lens, also called a concave/convex cylinder lens, may be a concave cylinder lens with two concave surfaces, a convex cylinder lens may be a convex cylinder lens with two convex surfaces or a concave and convex cylinder lens with a concave cylinder lens and a convex cylinder lens. The concave/convex cylinder lens is configured to expand the at least one light beam in the reception path of the lidar system as described above. The optical expander may comprise more than one convex/concave cylinder lens, e. g. in form of a cylinder lens array.

In an embodiment, the optical expander is configured to expand the at least one light beam in one predetermined direction. The one predetermined direction may be adapted for reception by the at least one pixel. For example, if the at least one pixel has a surface area which is larger in a first dimension than in a second dimension the expansion of the at least one light beam in the one predetermined direction may be in the first dimension. This means that the light beam is expanded in the dimension in which the pixel is also larger. This allows for more energy of the light beam to be absorbed by the pixel, because the illumination area of the pixel, i. e. the area that is hit by the expanded light beam, is larger. In the other dimensions of the at least one light beam, the high angular resolution of lidar may be kept.

The structure of a one-sided micro cylinder lens array comprises a substrate with micro cylinder lenses on one surface of the substrate. The structure of a two-sided micro cylinder lens array comprises a substrate with micro cylinder lenses on two surfaces of the substrate, e. g. on opposing surfaces of the substrate. The substrate preferably comprises an optically transparent material, like e. g. glass and/or plastic. The substrate serves as carrier for the micro lenses and may additionally have an optical characteristic which has an effect on the at least one light beam.

In an embodiment of the optical expander the expansion of the at least one light beam comprises increasing the diameter of the at least one light beam in the at least one direction and/or increasing the directions of the at least one light beam in the at least one direction. Depending on the type of optical expansion element, expanding the light beam may mean increasing the diameter of the at least one light beam and/or increasing the dimension of the at least one light beam.

When the aspect ratio of the beam expansion is not so large, a normal convex/concave lens can be applied. However, when the aspect ratio becomes larger, e.g. 1:5, 1:7 or 1:9 even larger, the curvature of the lens becomes larger. As a result, the total dimension of receiver of the lidar system becomes larger. In order to keep the lidar system design compact, a micro lens array may be introduced.

Micro lens arrays contain multiple micro lenses formed in a one-dimensional or two-dimensional array on a supporting substrate. A one-sided micro lens array comprises the array of micro lenses on one surface of the supporting substrate. The two-sided micro lens array comprises a micro lens array on two surfaces of the supporting substrate. Preferably, the two micro lens arrays of the two-sided micro lens array are located at opposing surfaces of the supporting substrate. A micro lens is a small lens, for example with a diameter of less than several millimetres, and possibly even as small as 10 μm. The small size of a micro lens offers large beam expanding without increasing the size of optical system. Cylindrical micro lenses at least partially comprise the shape of a cylinder. When the micro lens is made of glass, the substrate should not be thicker than the micro lens. The micro cylinder lens array may comprise convex and/or concave micro cylinder lenses. By suitably arranging convex and/or concave micro cylinder lenses on the one side of the substrate or on the two sides of the substrate the desired optical expansion can be achieved.

One micro cylinder lens of the array of micro cylinder lenses may be configured to expand the at least one light beam for reception by one pixel of a pixel array of the optical sensor. In connection with a beam steering optical element of the receiver of the lidar system light beams from a specific incident angle of the field of view of the radar system can be steered towards individual pixels of the optical sensor of the receiver. The optical expander can specifically expand the incoming beam to hit, i. e. illuminate, a larger area of the optical pixel of the optical centre. This allows to achieve a high optical resolution with respect to the incident angles and at the same time increase the area received by the pixel from the light beam.

An associated couple of micro cylinder lenses on opposing sides of the two-sided micro cylinder lens array is configured to expand the at least one light beam for reception by one pixel of the pixel array of the optical sensor. When designing optical characteristics of the two-sided micro cylinder lens array, one can take into account the micro cylinder lens on each side of the substrate and also take the thickness of the substrate with its optical refractive index into account for the overall design of the two-sided micro cylinder lens array. At the same time, when using the two-sided micro cylinder lens array in combination with the beam steering optical element the two micro cylinder lenses on each side of the substrate can operate together to effect the desired optical behaviour for one light beam passing through those two micro cylinder lenses operating together. The beam can be expanded to hit a larger area of the associated pixel of the optical sensor at the same time. In the other dimensions of the beam, where it is not expanded, the angular resolution with respect to the field of view of the lidar system can be maintained.

In embodiments, the supporting substrate comprises glass. In embodiments, the micro cylinder lenses have been produced by a casting method. In particular, it is possible to cast glass micro cylinder lenses on the supporting substrate.

In other embodiments, micro cylinder lenses comprise polymer material. Polymer micro cylinder lenses may be produced by a Polymer-on-Glass (PoG) method. This allows to produce Polymer micro cylinder lenses on supporting substrate comprising glass.

In other embodiments, the micro cylinder lenses may be produced by a Chip-on-Glass method. Using this method, the micro cylinder lenses may be manufactured and directly integrated on the glass substrate.

The thickness of the glass substrate may vary over its spatial extension or may be constant over its spatial extension. The thickness of the glass substrate may then be taken into account when designing the optical characteristics of the micro lens cylinder array. In particular, the refractive index of the micro cylinder lenses may depend on the thickness of the glass substrate. The desired optical characteristics may be designed taking into account the combination of the micro cylinder lenses and the substrate.

A lidar system comprises the optical expander in its receiving path. The receiver of the lidar system comprises the expander, which may be placed in between a concentrator lens and the optical sensor of the receiver. Alternatively, the concentrator lens may be placed in between the expander and the optical sensor of the receiver. Both optical setups are possible and may have advantages to achieve the desired optical characteristics in the receiving path of the lidar system and/or may have cost benefits. The lidar system further comprises a transmitter for emitting a transmission light beam and the control unit for controlling the emission and reception of the light beams, for object detection, for distance determination and/or for velocity determination within the field of view of the lidar system. Object detection, distance detection and relative velocity detection is performed using the emitted light and the received light.

In embodiments of the lidar system, the expander is arranged to expand the at least one light beam to be received by the at least one pixel of the optical sensor more evenly. This may allow to increase the effective area of reception for the received light beam in particular on the pixels which have dimensions which are not the same in one direction as compared to another direction of the reception area of the pixel. For the cases where the optical sensor comprises a pixel array, it may be advantageous to use an optical expander comprising a micro lens array to expand different light beams for the different pixels of the pixel array. Different light beams passing through the micro lens cylinder array are received from different incident angles of the field of view of the lidar system.

The pixel array of the optical sensor may be one-dimensional, i.e., formed in a row of pixels. The pixel array of the optical sensor may also be two-dimensional, i.e. formed in a two-dimensional area.

In an embodiment of the lidar system. The pixel array is one-dimensional with a row of pixels, wherein the surface area of the pixels is larger in the first dimension perpendicular to the row than in the second dimension in parallel to the row. The expander is arranged to expand the at least one light beam in one predetermined direction, wherein the one predetermined direction is in direction of the first dimension of the pixels, i.e. in the direction in which the pixels have a larger extension. In particular, the expander may comprise a micro lens cylinder array, which is configured to expand several light beams at the same time. Each light beam might then be associated with one pixel of the optical sensor. Each pitch of the micro lens cylinder array may then correspond to a micro cylinder lens, which may be configured to expand one light beam directed to one pixel.

In an embodiment the lidar system is a scanning type lidar system where the scanning direction is parallel to the one predetermined direction of expansion of the at least one light beam. This allows to preserve the high optical resolution of the incident angle in the direction perpendicular to the scanning direction. In the direction perpendicular to the scanning direction the light beam is not expanded in order to keep this high angular resolution.

### BRIEF DESCRIPTION OF THE FIGURES

Embodiments will now be described with reference to the attached drawing figures by way of example only. Like reference numerals are used to refer to like elements throughout. The illustrated structures and devices are not necessarily drawn to scale.

FIG. 1 schematically illustrates an optical expander in a receiving path of a lidar system.

FIG. 2 schematically illustrates the effect of an optical expander.

FIG. 3 schematically illustrates the effect of a one-sided micro cylinder lens array.

FIG. 4 schematically illustrates the effect of a one-sided micro cylinder lens array.

FIG. 5 schematically illustrates the effect of a diverging lens.

FIG. 6 schematically illustrates a Galilean telescope.

FIG. 7 schematically illustrates Keplerian telescope.

FIG. 8 schematically illustrates simulation results of the optical expander.

FIG. 9 schematically illustrates the effect of the one-sided and two-sided micro cylinder lens array.

FIG. 10 shows detection rate vs. detection range results for a lidar system.

FIG. 11 shows a schematic illustration of a vehicle with a lidar system and its field of view.

### DETAILED DESCRIPTION

FIG. 1 shows an optical receiver 30 of lidar system 50. Incoming light beams 12 pass through a beam steering system 14. The beam steering system 14 is configured to steer light beams 12 coming from different incident angles into different directions to be received by different pixels 22 of an optical sensor 20 of the optical receiver 30.

An optical expander 10 is arranged after the beam steering system 14. A concentrator lens 16 is arranged after the optical expander 10. The succession of the elements 14, 10, 16 is described in the direction of travel of the incoming light 12. In some embodiments, the optical expander 10 may be arranged after the concentrator lens 16. The concentrator lens 16 concentrates the incoming light 12 on pixels 22 of the optical sensor 20. The pixels 22 comprise a surface for receiving the incoming light beams 12. The dimension of the surface of the pixels 22 is larger in a first direction than in a second direction. The first direction is perpendicular to the second direction. Each pixel 22 comprises a number of single-photon avalanche diode (SPAD) 18. The single-photon avalanche diode 18 is a solid-state photodetector. A SPAD 18 reacts with a current when a photon is absorbed. The current increases with the number of photons that are received. SPADS 18 can detect single photons due to avalanche of current may be created by a received photon. A pixel 22 comprises three SPADS 18 in the second direction and nine SPADS 18 in the first direction. The extension of the pixel 22 in the first direction is thus three times larger than in the second direction. The optical expander 10 is configured and arranged so that incoming optical light beams 12 are expanded in the direction of the first dimension of the pixels 22.

The beam steering system 14 may for example comprise an optical phased array OPA. With an optical phased array it is possible to control the phase and amplitude of the light waves by a two-dimensional surface using adjustable surface elements.

The beam steering system 14, e. g. the optical phased array, might be used for transmitting, reflecting or capturing, i.e. receiving light beams 12. An optical phased array dynamically control the optical properties of its surface. It is possible to steer the direction of the light beams 12 thereby changing the view direction of an optical sensor 20 of the optical receiver 30. The beam steering system 14 may also be a rotating mirror/MEMS which reflects the incoming light beams 12 in different directions depending on the rotational position of the rotating mirror.

The light beams 12 are received by the concentrator lens 16, which might for example be a camera lens. The pixels 22 are arranged in a one-dimensional pixel array 21.

The optical receiver 30 may be arranged to receive the light in a scanning lidar system 50. The larger dimension of the pixels 22 are then for example arranged in the direction of the scanning lidar system 50. In the scanning lidar system 50 an optical transmitter 40 transmits scanning light beams 62 incrementally changing the direction of the beam 62 within the field of view 64 of the lidar system 50, thereby scanning the field of view 64. The scanning direction 66 is then the direction in which the position of the transmitted light beam 62 is incremented.

In the first direction of the pixels 22, where more SPADS 18 are comprised by the pixels 22 the dynamic range is increased. This may for example correspond to the scanning direction 66. In the second dimension where the number of SPADS 18 is smaller, e.g. three, the high angular resolution of the lidar system 50 is maintained. This would correspond to a direction perpendicular to the scanning direction 66. In the first direction, where the number of SPADS 18 is increased to for example 9 SPADS 18, the dynamic range of the lidar system 50 is increased.

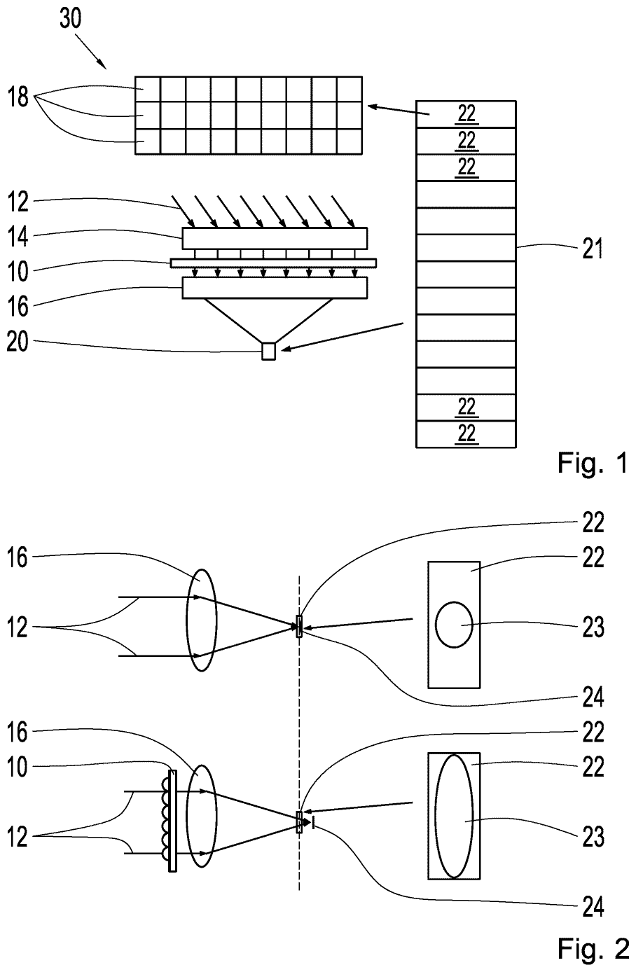

In FIG. 2 a receiving path with such a pixel 22 with the larger first dimension comprising nine SPADS 18 and a smaller second dimension comprising three SPADS 18 is shown to the right. In the upper part of FIG. 2 incoming light beams 12 are shown which are concentrated by the concentrator lens 16 on a pixel 22. In the upper part of FIG. 2 the concentrator lens 16 concentrates the light beams 12 on a focal plane 24 which is located on the receiving surface of the pixel 22. In the lower part of FIG. 2 another receiving path with pixel 22 and concentrator lens 16 is shown. The receiving path comprises the optical expander 10 in combination with the concentrator lens 16. The optical expander 10 expands the incoming light beams 12 and thereby moves the focal plane 24 to a location behind the pixel 22. This results in an expansion of the light beam 12 on the pixel 22. The expansion effect of the optical expander 10 is applied to one dimension of the light beam 12. This one direction corresponds to the first dimension of the pixel 22, which is larger than the second dimension of the pixel 22. With respect to the other dimensions of the optical beams 12 the expansion effect is not applied. This can be seen in the lower part of figure two, where the elliptical illuminated area 23, which is illuminated by the incoming beam is 12 is shown.

In the lower part of FIG. 2, the light 12 illuminates a larger area 23 on the pixel 22 than in the upper part of FIG. 2. The optical expander 10, which is inserted between the beam steering system 14 and the concentrator 16 expands the area of illumination 23. In a system with a pixel array 21, each pixel 22 corresponds to a certain incident angle. The optical expander 10 may expand the light 12 from each incident angle by increasing the dimension and/or the divergence of the light beam 12 in the direction of the larger dimension of the pixel 22.

In a scanning lidar system 50 this larger dimension may correspond to the scanning direction 66. The angular resolution perpendicular to this scanning direction is kept the same as before. Using micro cylinder lens arrays for the expander 10 allows to realise high aspect ratios of the pixels 22. This would otherwise require a very large curvature of an optical lens. It can be realised by micro lens arrays without increasing the size of the individual micro lens 26 of the array much. This allows for a compact realisation. Also, the micro lens array will increase the homogeneity of the beam 12 which can further increases the dynamic range of the receiver 30.

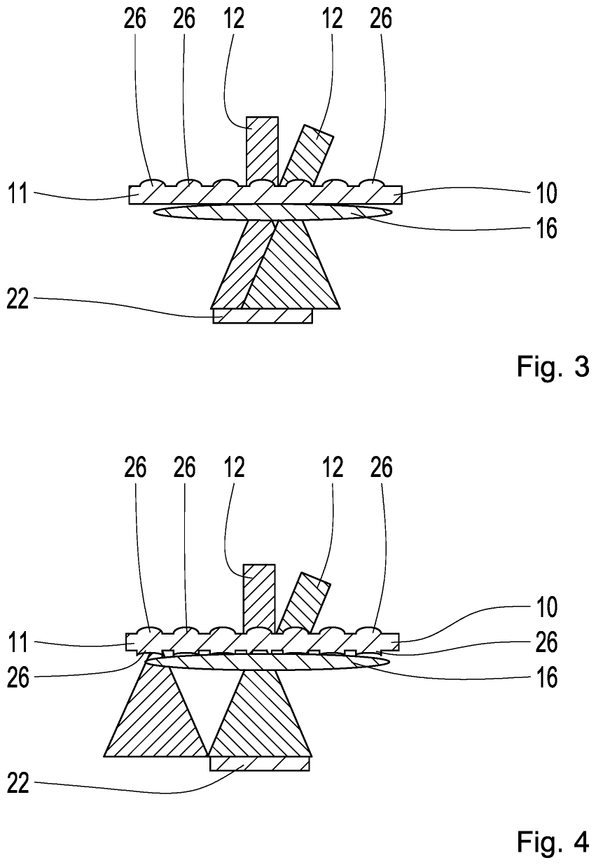

FIG. 3 shows a one-sided micro lens array 10 with individual micro lenses 26. The individual lenses 26 may also be called pitch. Incoming light beams 12 travel through the optical expander 10 and the concentrator lens 16 and are received by the pixel 22. The embodiment shown in FIG. 3 shows the one-sided micro cylinder lens array 10. One micro lens 26 may have a profile one side concave and one side convex, both sides concave or both sides convex. The proper designing of these properties can achieve in the desired optical effect. The advantage of such an optical expander 10 is that the cost can be quite low. Only one side of the optical expander 10 needs to be structured to expand the beam 12 as desired. Such an expander 10 can increase the dynamic range of the receiver 30.

Also shown in FIG. 3 is that the pixel 22 might also receive the beam 12 of another angular resolution, e. g. the neighbouring pitch. As a result, the pixel 22 may receive more noise and as a result, the detection range of the lidar system 50 might be reduced.

FIG. 4 shows an embodiment with a two-sided micro cylinder lens array 10. The two-sided micro cylinder lens array 10 comprises micro lenses 26 on two opposing surfaces of the substrate 11. Two micro lenses 26 opposite each other might be called pitch.

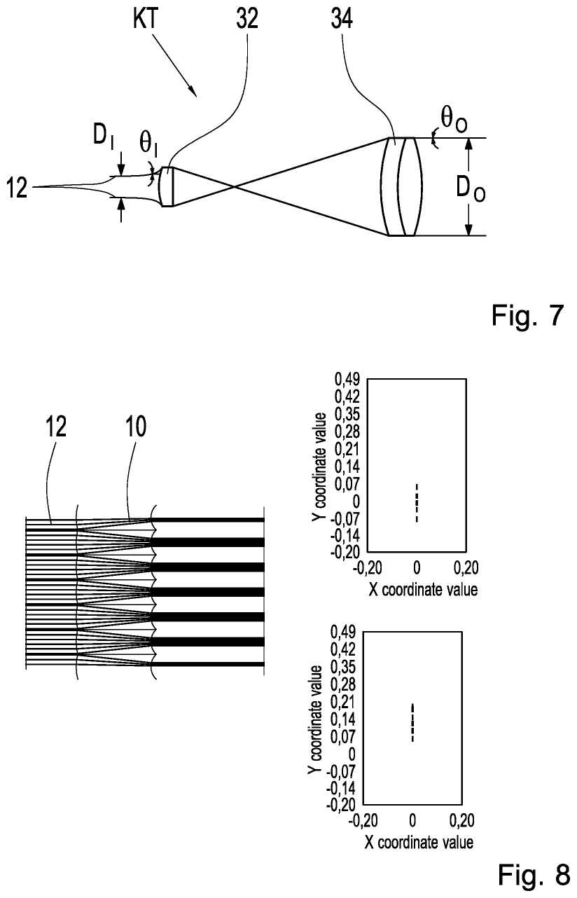

In the embodiment shown in FIG. 4, the two-sided micro cylinder lens array 10 shows micro lenses 26 which are convex on one side. These convex micro lenses 26 face the incoming reception light beams 12. On the opposing side of the micro cylinder lens array 10 the micro lenses 26 are concave. They face the concentrator lens 16. One pitch, i. e. two micro lenses 26 which are located directly opposite each other on the substrate 11 act together to achieve the desired optical effect on at least one light beam 12. With such a two-sided micro cylinder lens array 10 not only the expansion of the light beam 12 may be achieved, but also the so-called blooming effect of receiving light of neighbouring light beams 12 can be reduced significantly. This is illustrated in FIG. 4. The optical effect that is achieved by a pitch of two micro lenses 26 directly opposite each other on the substrate 11 is further illustrated with reference to FIG. 6 or FIG. 7 below.

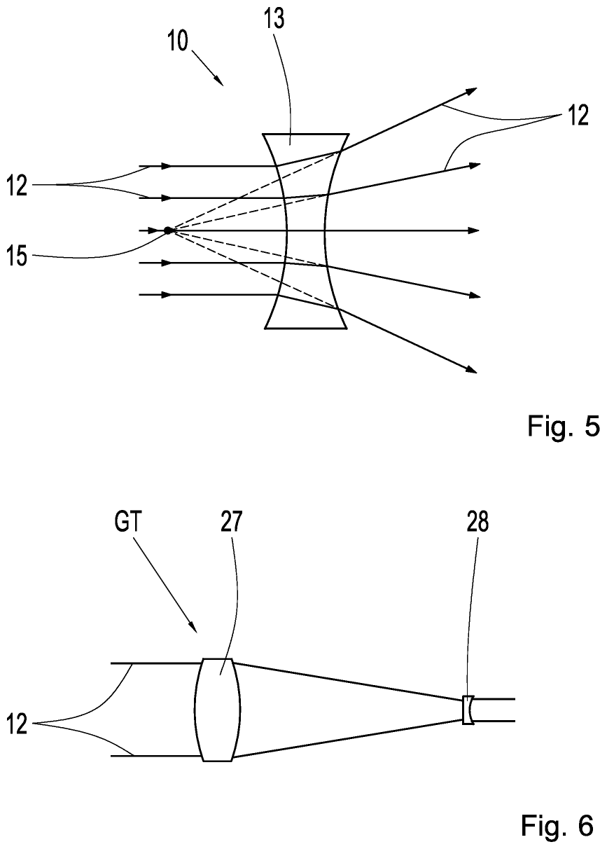

FIG. 5 shows an embodiment of a diverging lens 13, which may be comprised in an optical expander 10. The diverging lens 13 is an embodiment of a concave lens with two concave surfaces. Light beams 12 being in parallel to the diverging lens 13 are expanded to a diverging light beam 12 by the diverging lens 13. Such a diverging lens 13 may be used as an optical expander 10. The diverging rays of the outgoing light beams 12 have a virtual focal point 15.

FIG. 6 shows a Galilean telescope optical system GT. The Galilean telescope GT is an optical set up with a biconvex objective lens 27 and a biconcave eyepiece lens 28, also called camera lens or ocular lens. The biconvex objective lens 27 forms the image. The eyepiece lens 28, also called camera lens or ocular lens, is a biconcave and thus divergent lens. The camera lens is placed in front of the focus. The optical principle of the Galilean telescope GT with objective lens 27 and camera lens 28 comprises two elements. With the proper design of the two-sided micro cylinder lens array 10 these two elements 27, 28 can be replaced by a single pitch of double sided micro cylinder lens array 10. One of the micro lenses 26 of the pitch will perform the function of the objective lens 27 and that the other micro lens 26 of the pitch placed opposite the first micro cylinder lens 26 on the substrate 11 will perform the function of the camera lens 28. If this is properly designed each pitch of the micro cylinder lens array 10 can act and perform the optical effects of the Galilean telescope GT. The distance required between the objective lens 27 and ocular lens 28 can be achieved by the substrate 11.

Another embodiment for designing the optical characteristics of one pitch of a two-sided micro cylinder lens array 10 is shown in FIG. 7. FIG. 7 shows the optical principles of the Keplerian telescope KT. The Keplerian telescope KT comprises a positive objective lens 32 and a positive eyepiece or camera lens 34. The eyepiece or ocular or camera lens 34 is a positive, convex and thus convergent lens. It is placed in back of the focus of the other convergent objective lens 32. The two elements 32 and 34 can be realised by one pitch of a two-sided micro cylinder lens array 10 if it is properly designed. Such a pitch can then have the optical characteristics of the Keplerian telescope KT. The distance required between the objective lens 32 and ocular lens 34 can be achieved by the substrate 11.

The principle of applying either of the Galilean telescope GT or of the Keplerian telescope KT is to decrease the diameter of the beam 12 and to increase the divergence of the beam 12. This can be shown with respect to the following formula:

$$\frac{InputBeamDivergence ( {θ}_{I} )}{OutputBeamDivergence ( {θ}_{O} )} = \frac{OutputBeamDiameter ( {D}_{O} )}{InputBeamDiameter ( {D}_{I} )}$$

The advantage of using the two-sided micro cylinder lens array 10 is to keep the angular resolution of the system and to increase the dynamic range of the pixel 22. Also, the blooming effect due to crosstalk of neighbouring light beams 12 can be reduced.

Preferably, the micro lens cylinder array 10 is a glass micro cylinder array. Glass is not sensitive to temperature and an anti-reflective (AR) coating on glass is very stable. In order to reduce cost the expander 10 may be put behind the camera lens 16 between the camera lens and the pixel 22. In such an embodiment the optical expander 10 due to smaller size might be designed more cost effectively. The material of the micro cylinder lens array 10 may be plastic, such as PMMA or hybrid material, such as Polymer combined with a Chip-on-Glass material. Using such plastic material may allow to reduce the cost. On the other hand, plastic and/or polymer is more sensitive to temperature than glass, as it shows strong thermal expansion coefficients. Also, antireflective coating is less adhesive on polymer as compared to glass. Thus, depending on the actual use case either glass and/or plastic may be chosen as the material comprised in the substrate 11 and/or the micro lenses 26.

FIG. 8 shows simulation results for the beam expander 10. The left part of FIG. 8 shows how the light beam 12 propagates through the optical expander 10. The diameter in one pitch after the optical expander 10 reduces three times for the light beam 12. However, the divergence angle increases three times. This is shown in the right half FIG. 8, where results for two examples of incident angles are shown. The y-axis of the right pictures of FIG. 8 show the distribution of the output angles for the light beams 12 for two different input incident angle distribution. The top right picture shows the distribution of the output angle for an incident angle of −0.025° to +0.025°. The lower right picture of FIG. 8 shows the distribution of output angles and for incident angles from −0.075° to −0.025°. It can be seen that the output angle is −0.075° to +0.075° for an input angle of −0.025° to 0.025° (top picture). For the incident angle of −0.075° to −0.025° an output angle of +0.075° to +0.225° is achieved, as shown in the lower right figure of FIG. 8. Thus, the effect for the optical expander 10 to increase divergence of the optical beam 12 can be shown in simulation.

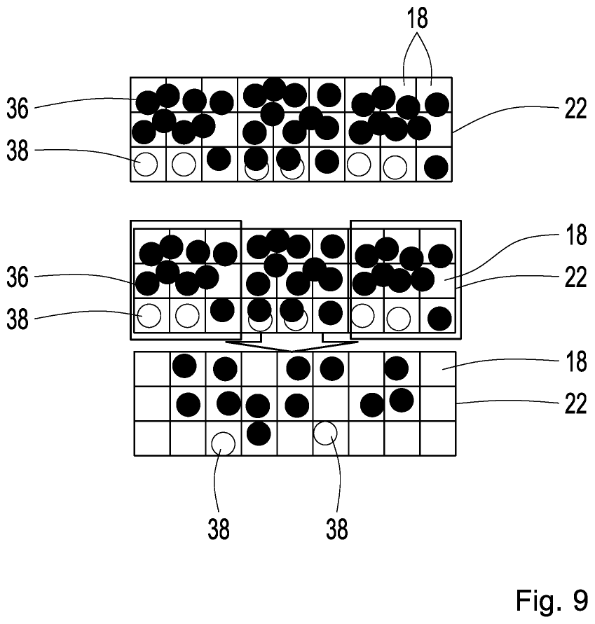

In FIG. 9 pixels 22 are shown with signal photons 36 and noise photons 38. Each pixel 22 shown comprises SPADS 18. In the top pixel 22 shown in FIG. 9 no optical expander 10 is applied. In the middle pixel 22 shown a one-sided micro cylinder lens array 10 is applied. In the lower part of FIG. 9 a two-sided micro cylinder lens array 10 is applied. It can be seen that the two-sided micro cylinder lens array 10 significantly reduces blooming, as can be seen by the reduced number of photons 38. It can be seen that a two-sided micro cylinder lens array 10 can reduce crosstalk from neighbouring light beams 12 significantly.

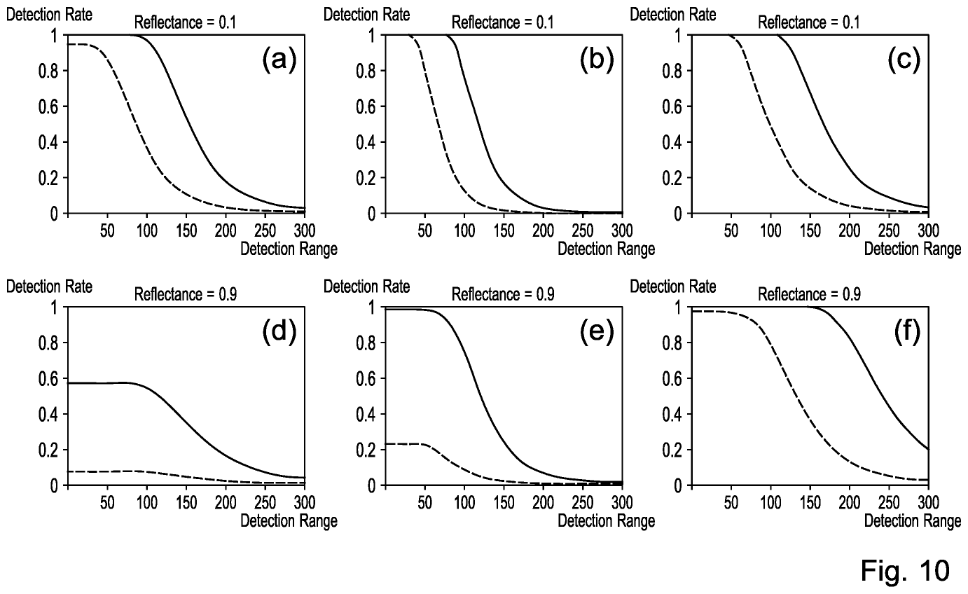

In FIG. 10 the two pictures a), d) to the left show results for a lidar system 50 with no optical expander 10. In comparison, the middle column shows results b), e) for a lidar system 50 with a one-sided micro cylinder lens array 10 and the right column shows results c), f) for a lidar system 50 with two-sided optical micro cylinder lens array 10. The graphs show curves of detection rate, y-axis, over detection range, x-axis, in meter. Drawn on the x-axis is a detection range between 0 and 300 m. Drawn on the y-axis is a detection rate between 0 and 1.0. It can be seen that the application of an optical expander 10 significant currently improves the detection rate as well as the detection range.

Dashed lines in each graph show the measurements for single shot measurements, i. e. the measurements after one short of transmitted light 62. The solid lines shown in the graphs of FIG. 10 give 7-shot measurements. 7-shots measurements give the measurements after seven shots of transmitted light 62. a), b), c) give the detection rate over detection range for low reflective targets with around 10% reflectance. Graphs d), e) and f) indicate the detection rate over detection range for high reflective targets with around 90% reflectance. The graphs show that one-sided or two-sided micro cylinder lens arrays 10 increase the detection rate compared to a system without optical expander 10 in the reception path. One-sided micro cylinder lens array 10 can increase the dynamic range. The two-sided pro cylinder lens array 10 as shown in the right column does not reduce the detection range for low reflective targets and at the same time shows a very large detection range at detection rate for high reflective targets and for low reflective targets.

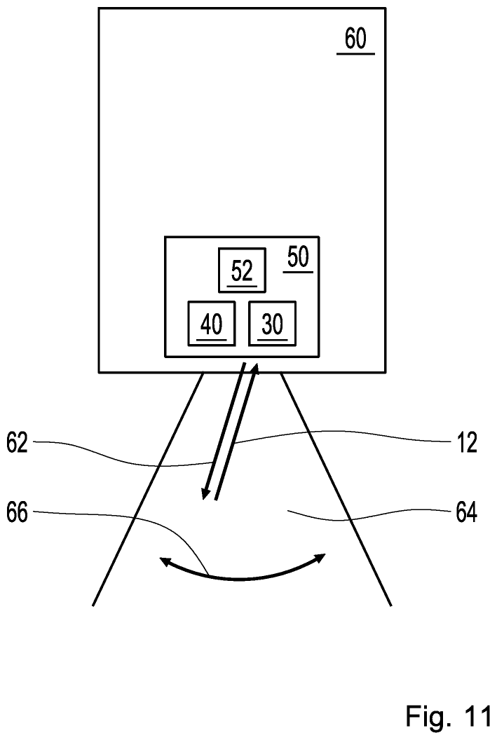

FIG. 11 schematically shows a vehicle 60, for example a passenger car. The lidar system 50 is arranged in a front area of the vehicle 60. The lidar system 50 comprises the optical transmitter 40 and the optical receiver 30. In the control unit 52, the transmitted and received light beams 62, 12 can be evaluated, e. g. as time-of-flight measurements, for e. g. object detection and/or distance detection in a monitoring area of the field of view 64. The transmitting process in the transmitter 40, the receiving process in the receiver 30 and beam steering of transmitted and received light beams can also be monitored and controlled by the control unit 52.

The field of view 64 is located in front of the front area of the vehicle 60. Thus, in the example shown, an area in front of the vehicle 60 in the direction of travel can be monitored. It is also possible to arrange the lidar system 50 in other areas of the vehicle 60, for example in the rear area and/or in side areas. It is also possible to arrange several lidar systems 50 on the vehicle 60, in particular also in corner areas of the vehicle 60.

The lidar system 50 can be used to detect stationary or moving objects, in particular vehicles, persons, animals, plants, obstacles, road irregularities, in particular potholes or stones, road boundaries, traffic signs, open spaces, bridges in particular parking spaces, precipitation or the like, in the field of view 64.

It is possible to steer the transmitting light beam 62 by means of e. g. a mirror element or an optical phased array in the transmitting light path in such a way that it glides over the field of view 64 and scans it in the scanning direction 66, i.e. lights it incrementally step-by-step in the scanning direction 66. The transmitting light beam 62 is then reflected back as a reflected light beam 12 by objects in the field of view 64 to be received by the receiver 30. In the embodiment shown in FIG. 11, the scanning direction 66 extends in horizontal direction in front of the car.

1. An optical expander for a receiving path of a lidar system, configured to expand at least one light beam for reception by at least one pixel of an optical sensor of the lidar system, the optical expander comprising:
at least one of a concave and/or convex cylinder lens; and
a structure of a one-sided micro cylinder lens array or a structure of a two-sided micro cylinder lens array.

2. The optical expander according to claim 1, configured to expand the at least one light beam in one predetermined direction, for reception by the at least one pixel, wherein a surface area of the at least one pixel is larger in a first dimension than in a second dimension.

3. The optical expander according to claim 1, wherein an expansion of the at least one light beam comprises increasing a diameter of the at least one light beam in at least one direction and/or increasing a divergence of the at least one light beam in the at least one direction.

4. The optical expander according to claim 1, wherein the micro cylinder lens array comprises convex and/or concave micro cylinder lenses.

5. The optical expander according to claim 3, wherein one micro cylinder lens of the one-sided micro cylinder lens array is configured to expand the at least one light beam for reception by one pixel of a pixel array of the optical sensor.

6. The optical expander according to claim 3, wherein one micro cylinder lens on each side of the two-sided micro cylinder lens array is configured to expand the at least one light beam for reception by one pixel of a pixel array of the optical sensor.

7. The optical expander according to claim 4, wherein the micro cylinder lens array comprises a supporting substrate.

8. The optical expander according to claim 6, wherein the micro cylinder lenses have been produced by a casting method.

9. The optical expander according to claim 6, wherein the micro cylinder lenses comprise polymer material and have been produced by a Polymer-on-Glass method.

10. The optical expander according to claim 7, wherein thickness of the supporting substrate varies or is constant over its spatial extension.

11. The optical expander according to claim 10, wherein a refractive index of the micro cylinder lenses depends on the thickness of the supporting substrate.

12. A lidar system comprising the optical expander according to claim 1 in its receiving path, wherein the optical expander is placed in between a concentrator lens and the optical sensor or wherein the concentrator lens is placed in between the expander and the optical sensor.

13. The lidar system according to claim 12, wherein the expander is arranged to expand the at least one light beam to be received by the at least one pixel of the optical sensor more evenly.

14. The lidar system according to claim 12,
wherein the optical sensor comprises a pixel array with a row of pixels,
wherein a surface area of the pixels is larger in a first dimension perpendicular to the row than in a second dimension in parallel to the row,
wherein the optical expander is arranged to expand the at least one light beam in one predetermined direction, and
wherein the one predetermined direction is in direction of the first dimension of the pixels.

15. The lidar system according to claim 12, wherein the lidar system is a scanning type lidar system where a scanning direction is parallel to one predetermined direction of expansion of the at least one light beam.
